(19) United States
(12) Patent Application Publication
(10) Pub. No.: US 2018/0259790 A1
(43) Pub. Date: Sep. 13, 2018

(54) RIGID EYEWEAR HAVING A DETACHABLE PLAYLESS NOSE BRIDGE

(71) Applicants: Christopher Miller, Draper, UT (US); Steven L. Rinehart, Fruit Heights, UT (US)

(72) Inventors: Christopher Miller, Draper, UT (US); Steven L. Rinehart, Fruit Heights, UT (US)

(21) Appl. No.: 15/965,917

(22) Filed: Apr. 28, 2018

(51) Int. Cl. G02C 5/02; G02C 5/00

(52) U.S. Cl. CPC G02C 5/02; G02C 2200/08; G02C 5/008

(57) ABSTRACT

Eyeware having a detachable nose bridge affixed using set screws in some embodiments to inserted tabs cantilevering from eyewires to eliminate play within the nose bridge, the tabs defining concave forward surface recesses for set screw engagement. In other embodiments, the nose bridge and each eyewire is affixed using a plurality or roughly horizontally-running bolts to eliminate play between the nose bridge and eyewires. The eyewear reduces ricketiness and enhances functionality, ergonomic comfort, and aesthetics of rigid eyewear. Eyewires retain one or more lenses.

### BACKGROUND

### Field of the Invention

This invention relates to eyewear, and more particularly relates to the nose bridge of eyewear interconnecting eyewires/rims.

### Description of the Related Art

The eyewires in typical eyewear in the art are interconnected with a nose bridge. In some prior art, though not exclusively, the nose bridge has been formed as a single integrated piece with the eyewires to save on production costs and because of problems inherent in the art is securely and playless affixing a nose bridge between two eyewires.

Better eyewear, including glasses, sunglasses and protective safety wear, typically comprises eyewires which entirely circumscribe a lens (eyewires are also nomenclatured as rims or frames) and securely retain the lenses in front of the eyes of a wearer, both protecting the lenses from impact and the wearer's from cutting themselves on the edges of the lenses. The lenses are usually used for vision correction and/or for reducing glare, transmission of sunlight, or brightness to a wearer—or for safety protection from projectiles in work place environments.

More expensive eyewear often fabricated from metal and metal alloys, have made more common usage of separately manufactured nose bridges than polymeric eyewear. Consumers of high end eyewear recognize the precision eyewear is not typically manufactured as a single piece and prefer to be able to detach, adjust and replace scratched, bent or worn components of the sunglass assemblies. The lenses are sometimes permanently sealed inside the frames in cheaper eyewear. Cheaper eyewire is known to break easily or be so lightly fitting that is distorts and blows from user's face with even light impact or in high wind conditions (such as those experienced boating, skiing, snowmobiling, motorcycling, and the like). These cheaper glasses are not made of strong enough materials to assert sufficient grip on a wearer's head to stay in place without breaking.

In the prior art, metal alloy and titanium eyewear in which the eyewires are affixed to a nose bridge has suffered from a number of weaknesses and inefficiencies. Firstly, the axial force or torque applied to nose bridge is high from tensile force applied by both sides a wearer's head to the open arms. The arms act as levers with the nose bridge as fulcrum, the nose bridge becoming the leverage point where pressure is the most concentrated. For this reason, tabs inserting from the eyewires into the nose bridge in limited spacing conditions weaken and break over time. Some manufacturers have attempted to insert polymeric pads into the nose bridge along side the tabs to absorb pressure and allow the sunglasses to flex to accommodate varying size heads. These pads reduce the thickness available in tab design within the nose bridge, causing weak tabs to be used which bend, break and deform. The polymeric pads compress over time, causing the nose bridge to become rickety (or have play) between the eyewires and the tabs, the pads also causing the natural sunglasses fit to expand, reducing optimal fit. To prevent the ricketiness, very low tolerances are needed between the tabs and recess in which the tabs position. These tolerances have been difficult to achieve using traditional manufacturing processes. Even when the tolerances are low, ricketiness still occurs as components weaken, bow, and flex over time. There has been no solution known in the art. Traditional nose bridge tabs have not been easily interchangeable/detachable, nor attachment mechanisms adjustable.

Sunglasses are being worn by ever increasing numbers of people, many of whom prefer sunglasses made from high-strength metal alloys rather than plastic sunglasses manufactured for the lowest production costs possible. To some wearers, sunglasses have become an extension of their appearance and identity, driving highly priced, highly ornamental sunglasses, into larger and larger portions of the market. The increasing demand for sunglasses specifically and eyewear generally has resulted in a proliferation of designs for sunglasses. Thus some sunglasses are designed primarily to meet functional objectives, while others are more stylish.

Sunglasses typically come in a one size fits all configuration, whereby such glasses can be a misfit, either too small or too large for the various head sizes and dimensions, including those of soldiers, athletes, skiiers, motorcyclers, drivers, and professionals.

There exists a need in the art for a pair of sunglasses having strong detachable nose bridges which can be securely and easily affixed to the nose bridges and which have little or no play. Current solutions in the art are not effective and unknown.

### SUMMARY

From the foregoing discussion, it should be apparent that a need exists for high-strength eyewear having a detachable, playless nose bridge. Beneficially, such eyewear would overcome the above-described deficiencies with the prior art.

The present invention has been developed in response to the present state of the art, and in particular, in response to the problems and needs in the art that have not yet been fully solved by currently available glasses. Accordingly, the present invention has been developed to provide eyewear comprising: two eyewires adapted to circumscribe one or more lenses, each eyewire forming a circuitous rim adapted to receive and secure a lens, each eyewire comprising a lateral tab cantilevering from a lateral edge for insertable disposition within a nose bridge; wherein each lateral tab defines a concave recess on a forward surface for receiving a set screw; a nose bridge detachably affixed to each eyewire, the nose bridge defining a horizontally-running cavity traversing the nose bridge with two lateral side openings for receiving tabs of each eyewire, a forward surface of the nose bridge defining two or more threaded bore holes, each threaded bore hole for receiving a set screw traversing the forward wall and engaging a tab within the horizontally-running cavity by inserting into a concave recess; wherein each set screw is adapted to eliminate play by pressing a tab against a rearward wall of the nose bridge.

The set screws may penetrate the nose bridge at a non-orthogonal orientation to the top surface of the tabs such that the set screw apply compressive lateral force to tab.

The eyewear may further comprise one or more long bolts affixing an eyewire and the nose bridge.

In various embodiments, the eyewear further comprises four or more set screws.

The nose bridge may be formed from one of Titanium, a Titanium alloy, aluminum and an aluminum alloy.

Eyewear is also provided comprising: two eyewires adapted to circumscribe one or more lenses, each eyewire forming a circuitous rim adapted to receive and secure a lens, each eyewire comprising a lateral tab cantilevering from a lateral edge for insertable disposition within a nose bridge; wherein each lateral tab defines a concave recess on a forward surface for receiving a set screw; a nose bridge detachably affixed to each eyewire, the nose bridge defining one or more horizontally-running cavities for receiving a tab, each cavity having a lateral side opening for receiving a tab of an eyewire; wherein a forward surface of the nose bridge defines two or more threaded bore holes, each threaded bore hole for receiving a set screw traversing the forward wall and engaging a tab within the horizontally-running cavity by inserting into a concave recess; wherein each set screw is adapted to eliminate play by pressing a tab against a rearward wall of the nose bridge.

The set screws may penetrate the nose bridge at a non-orthogonal orientation to the top surface of the tabs such that the set screw apply compressive lateral force to tab.

The eyewear may further comprise one or more long bolts affixing an eyewire and the nose bridge.

The eyewear, in some embodiments, further comprises four or more set screws.

The nose bridge may be formed from one of Titanium, a Titanium alloy, aluminum and an aluminum alloy.

Eyewear is also provided comprising: two eyewires adapted to circumscribe one or more lenses, each eyewire forming a circuitous rim adapted to receive and secure a lens, each eyewire defining two or more bore holes for receiving a threaded long bolt; a nose bridge detachably affixed to each eyewire, the nose bridge defining one or more horizontally-running bore holes for receiving a threaded long bolt tab, each bore hole having a lateral side opening; wherein each long bolt is adapted to eliminate play between an eyewire and nose bridge by allowing said eyewire and nose bridge to forced against one another using the long bolts.

The nose bridge may be formed from one of Titanium, a Titanium alloy, aluminum and an aluminum alloy.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a front side perspective view of multipurpose eyewear with a playless nose bridge in accordance with the present invention;

FIG. 2 is a side perspective view of multipurpose eyewear with a playless nose bridge in accordance with the present invention;

FIG. 3 is a front perspective view of the nose bridge of multipurpose eyewear in accordance with the present invention;

FIG. 4 is a side perspective view of the nose bridge of multipurpose eyewear in accordance with the present invention;

FIG. 5 is a front side perspective view of disassembled multipurpose eyewear in accordance with the present invention;

FIG. 6 is a front side perspective view of disassembled multipurpose eyewear in accordance with the present invention; and

FIG. 7 is a front perspective view of eyewear in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

One object of the present invention is to provide eyewear comprising, in some embodiments, a nose bridge which securely and playless affixes to a pair of eyewires.

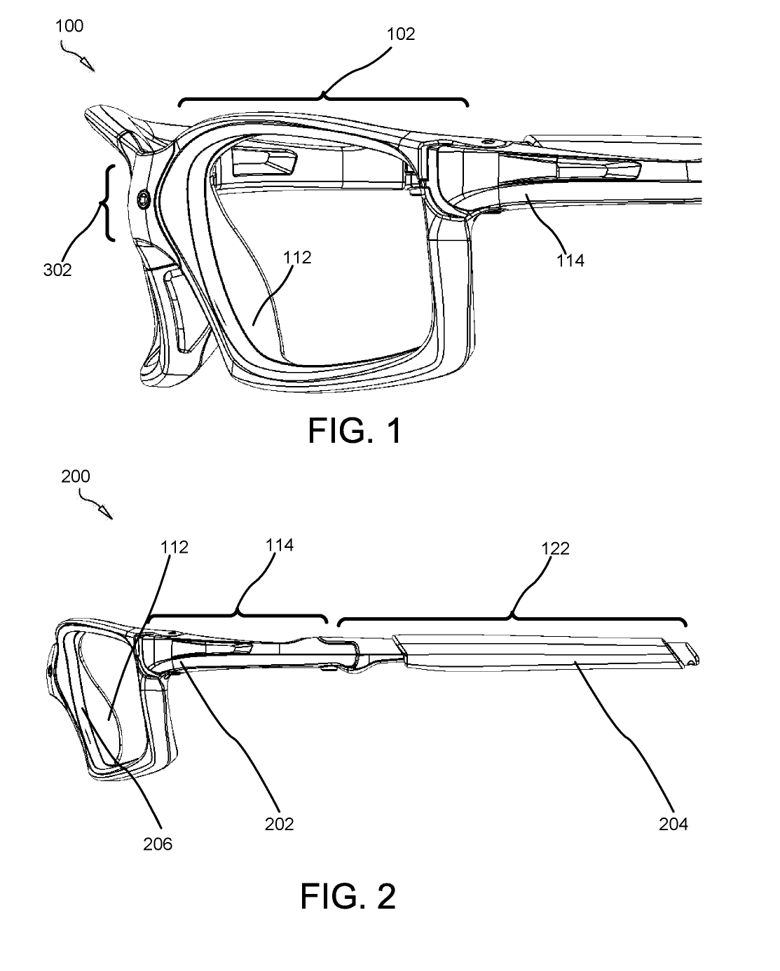

FIG. 1 is a front side perspective view of multipurpose eyewear with a playless nose bridge 100 in accordance with the present invention. FIGS. 1-2 depict multipurpose eyewear comprising a pair of forward arms 114 and a pair of rearward arms 122 that pivot laterally, in an inner and outer direction, to increase the width of the glasses 100. The glasses 100-200 provide multiple components that enhance functionality and aesthetics. The glasses 100-102 may comprise of eyewires 102, a pair of forward arms 114a-b, and a pair of rearward arms 122a-b. The eyewires 102 circumscribe a lens. These components join together to form a dynamic pair of glasses 100-200 that integrates various components and configurations to provide advantages over the prior art.

As shown in FIG. 1, the frame/eyewire 102 is configured to rest on the nose for supporting the glasses 100. The eyewire 102 detachably retains a pair of lenses. The eyewire 102 is for releasing the lenses and the arms. The eyewire 102 can also tighten using means known to those of skill in the art. This enables the lenses to be interchanged and securely retained with minimal stress within an eyewire 102.

In various embodiments, two eyewires 102 are permanently or detachably affixed to a nose bridge (indicated at 302). In other embodiments, the eyewires 102 are affixed together or formed as a single integrated piece. In these embodiments, a single eyewire 102 envelopes or circumscribes two lenses and is adapted to straddle a wearer's nose.

The nose bridge 302 in the shown embodiment comprises a convex forward surface and concave rearward surface.

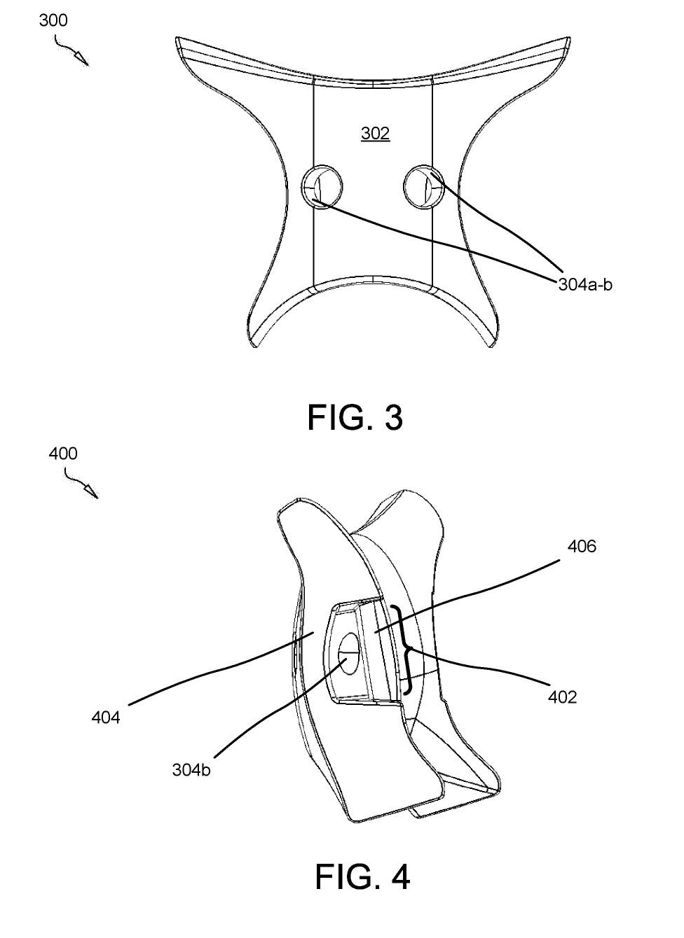

The eyewire 102 in the shown embodiment is interrupted at the point where the arm 114 engages the eyewire 102. The eyewire 102 does not form a single, uninterrupted ovoid circumscribing the entire lens. Rather a break in the circuity of the eyewires is formed in the outer lateral edge as further described below in relation to FIGS. 3-4B. A pair of forward arms 114 hingedly join the eyewire 102 and insert into the formed recess.

The nose bridge 302 may be fabricated from titanium, aluminum, steel, brass, gold, gold plating, carbon fiber, metal alloys, nylon, elastomeric or polymeric materials, or organic materials such as wood, or other materials known to those of skill in the art, using means known to those of skill in the art, including mold injection, 3D printing, or digital metal laser sintering (DMLS). In other embodiments, the nose bridge 302 and/or eyewires 102 are fabricated from polymeric or organic materials (e.g., wood or leather).

The proximal end of the arm 114 is indicated at 202 while the distal end is indicated at 204. Each eyewire 102 comprises a circuitous rim 206 adapted to receive and secure an inserted and detachable lens. In some variations, the rim 206 defines a track, groove 412, recess, or slot for receiving the lens.

FIG. 3 is a front perspective view of the nose bridge of multipurpose eyewear 300 in accordance with the present invention.

The forward wall 404 of the nose bridge 302 defines two threaded bore holes 304a-b for receiving a set screw (indicated below at 506). These bore holes 304a-b traverse a forward wall 404 of the nose bridge 302, but not the rearward wall 406.

FIG. 4 is a side perspective view of the nose bridge of multipurpose eyewear 400 in accordance with the present invention.

An interior cavity, recess 402 or channel traverses the nose bridge 400 laterally from side to side. The tabs 504 of the eyewires 102 each insert into the nose bridge 302.

In various embodiments, the nose bridge 400 defines a recess 402 traversing the entire width of the nose bridge 400. In other embodiments, the nose bridge 400 defines two separate recesses 402, each for receiving a tab 504, which do not meet nor intersect in the center of the nose bridge 400.

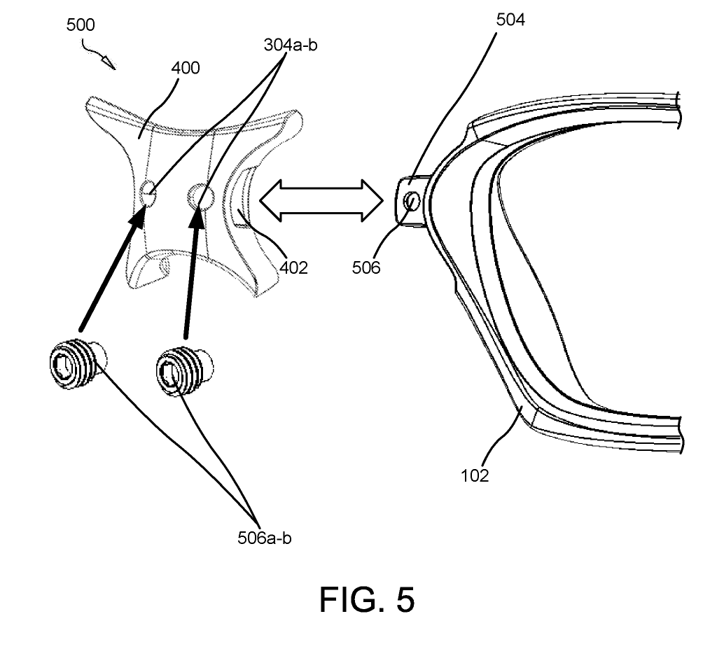

FIG. 5 is a front side perspective view of disassembled multipurpose eyewear 500 in accordance with the present invention.

The eyewire 102 comprises tabs 504 which insert into the recess 402 of the nose bridge 400. The recess 402 comprises a horizontally-running cavity for receiving the tabs 504, which cavity has two lateral side openings, one for each tab 504.

The tabs 504 define a concave recess on a forward surface for receiving the unthreaded ends of the set screws 506. The tabs 504 are secured in place playlessly when the set screws 506 are tightened within the nose bridge 302.

In various embodiments, the set screws 506 do not sit orthogonal to the top surface of the tabs 504 when the set screws 506 are received in the bore holes 304, rather the set screws 506 angle inwardly to push the eyewire 102 tabs 504 together as the set screws progressively insert into the bore holes 304.

The set screws 506 threadably penetrate the forward wall 404 of the nose bridge 302 and engage the tab 504 of the eyewire 102. The set screws 506 press the tabs 504 against the rearward wall 406 of the nose bridge 302 eliminating play between the forward surface of the tab 504 and the forward wall 404 as well as eliminating play between the rearward surface of the tab 504 and the rearward wall 406.

A pair of set screws 506 penetrates the forward wall 404. In alternative embodiments, set screws 506 may alternatively or additionally penetrate the rearward wall 406.

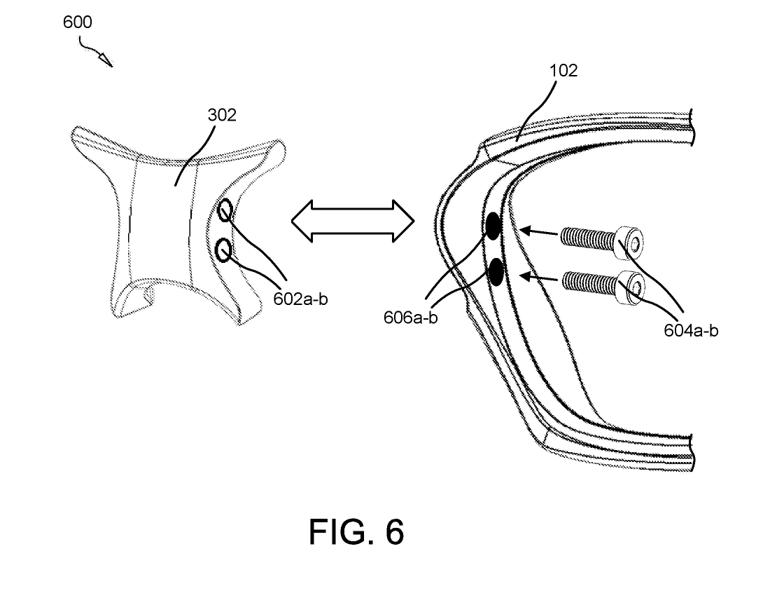

FIG. 6 is a front side perspective view of disassembled multipurpose eyewear 600 in accordance with the present invention.

In some variations of the present invention, the nose bridge 302 is formed without the bore holes 304 and the eyewires 102 with or without the tabs 504. In these variations, the eyewires 102 may detachable affix to the nose bridge 302 using one or more long bolts 604. In some variations, each eyewire 102 affixes to the nose bridge 302 using a single long bolt 604. In other variations, each eyewire 102 affixes to the nose bridge 302 using a plurality of long bolts 604a-b as shown.

The eyewires 102 may define one or more bore holes 606a-b as shown.

The long bolts 604 interconnect the eyewires 102 and nose bridge 302. A single interconnecting long bolt may not be strong enough to withstand tensile or axial forces applied between a eyewire 102 and the nose bridge 302. As such, a plurality of long bolts 604 may be required at each eyewire 102 junction.

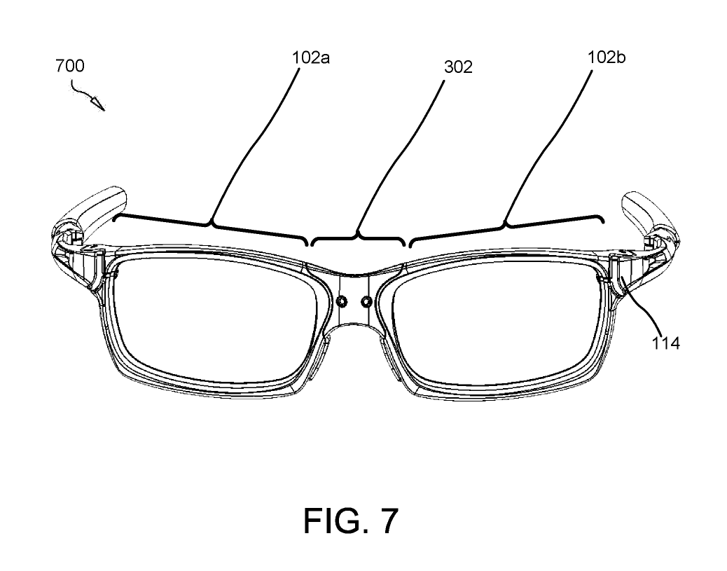

FIG. 7 is a front perspective view of eyewear 700 in accordance with the present invention.

FIG. 7 as shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. Eyewear comprising:
two eyewires adapted to circumscribe one or more lenses, each eyewire forming a circuitous rim adapted to receive and secure a lens, each eyewire comprising a lateral tab cantilevering from a lateral edge for insertable disposition within a nose bridge;
wherein each lateral tab defines a concave recess on a forward surface for receiving a set screw;
a nose bridge detachably affixed to each eyewire, the nose bridge defining a horizontally-running cavity traversing the nose bridge with two lateral side openings for receiving tabs of each eyewire, a forward surface of the nose bridge defining two or more threaded bore holes, each threaded bore hole for receiving a set screw traversing the forward wall and engaging a tab within the horizontally-running cavity by inserting into a concave recess;
wherein each set screw is adapted to eliminate play by pressing a tab against a rearward wall of the nose bridge.

2. The eyewear of claim 1, wherein the set screws penetrate the nose bridge at a non-orthogonal orientation to the top surface of the tabs such that the set screw apply compressive lateral force to tab.

3. The eyewear of claim 1, further comprising one or more long bolts affixing an eyewire and the nose bridge.

4. The eyewear of claim 1, further comprising four or more set screws.

5. The eyewear of claim 1, wherein the nose bridge is formed from one of Titanium, a Titanium alloy, aluminum and an aluminum alloy.

6. Eyewear comprising:
two eyewires adapted to circumscribe one or more lenses, each eyewire forming a circuitous rim adapted to receive and secure a lens, each eyewire comprising a lateral tab cantilevering from a lateral edge for insertable disposition within a nose bridge;
wherein each lateral tab defines a concave recess on a forward surface for receiving a set screw;
a nose bridge detachably affixed to each eyewire, the nose bridge defining one or more horizontally-running cavities for receiving a tab, each cavity having a lateral side opening for receiving a tab of an eyewire;
wherein a forward surface of the nose bridge defines two or more threaded bore holes, each threaded bore hole for receiving a set screw traversing the forward wall and engaging a tab within the horizontally-running cavity by inserting into a concave recess;
wherein each set screw is adapted to eliminate play by pressing a tab against a rearward wall of the nose bridge.

7. The eyewear of claim 1, wherein the set screws penetrate the nose bridge at a non-orthogonal orientation to the top surface of the tabs such that the set screw apply compressive lateral force to tab.

8. The eyewear of claim 1, further comprising one or more long bolts affixing an eyewire and the nose bridge.

9. The eyewear of claim 1, further comprising four or more set screws.

10. The eyewear of claim 1, wherein the nose bridge is formed from one of Titanium, a Titanium alloy, aluminum and an aluminum alloy.

11. Eyewear comprising:
two eyewires adapted to circumscribe one or more lenses, each eyewire forming a circuitous rim adapted to receive and secure a lens, each eyewire defining two or more bore holes for receiving a threaded long bolt;
a nose bridge detachably affixed to each eyewire, the nose bridge defining one or more horizontally-running bore holes for receiving a threaded long bolt tab, each bore hole having a lateral side opening;
wherein each long bolt is adapted to eliminate play between an eyewire and nose bridge by allowing said eyewire and nose bridge to forced against one another using the long bolts.

12. The eyewear of claim 1, wherein the nose bridge is formed from one of Titanium, a Titanium alloy, aluminum and an aluminum alloy.
